(19) United States
(12) Patent Application Publication
(10) Pub. No.: US 2026/0321023 A1
(43) Pub. Date: Oct. 15, 2026

(54) METHOD FOR OBSTACLE DETECTION, CLASSIFICATION, AND TRACKING

(71) Applicant: Topcon Positioning Systems, Inc., Livermore, CA (US)

(72) Inventors: Mikhail Yurievich VOROBIEV, Moscow (RU); Ivan Alexandrovich BOGDANYUK, Vladivostok (RU); Nikita Andreevich KUTKIN, St. Petersburg (RU)

(73) Assignee: Topcon Positioning Systems, Inc., Livermore, CA (US)

(21) Appl. No.: 19/484,001

(22) PCT Filed: May 23, 2023
(86) PCT No.: PCT/RU2023/000150

§ 371 Date: Nov. 13, 2025

(51) Int. Cl. G06V 20/58; G06V 10/26; G06V 10/82

(52) U.S. Cl. CPC G06V 20/58; G06V 10/26; G06V 10/82

(57) ABSTRACT

A method for identifying, classifying, and tracking obstacles includes scanning an area using a scanner, such as stereo camera, to generate a point cloud of the area. A ground plane of the area is determined based on the point cloud and obstacles in the area are identified based on the point cloud. Obstacles are classified based on the point cloud and obstacles are tracked based on a series of point clouds generated by the scanner over time.

### FIELD OF THE INVENTION

The present disclosure relates generally to methods for imaging, and, more particularly, to a method for obstacle detection, classification, and tracking.

### BACKGROUND

Operation of machines that can move about an environment require awareness of obstacles in the environment either by an operator or a controller for autonomous operation of the machine. When a machine is operated manually, the operator is responsible for seeing and avoiding obstacles. However, accidents can occur for a variety of reasons including fatigue, poor visibility, inattention, etc. Detection and avoidance of obstacles by autonomous vehicles is required to prevent collisions. What is needed is a method for detecting and tracking obstacles that can be used to assist manned operation of equipment and can also be used to facilitate autonomous operation of vehicles and/or equipment.

### SUMMARY

A method for obstacle detection, classification, and tracking includes scanning an area using a scanner to generate a point cloud. A ground plane is determined based on the point cloud and obstacles in the area are identified based on points in the point cloud in relation to the ground plane. The determining can include dividing an approximate ground plane into a plurality of cells, determining a maximum height of points in each of the plurality of cells above the approximate ground plane, and categorizing each of the plurality of cells into one of a ground plane and not a ground plane based on the maximum height of points in the cell. The scanner can be mounted on a machine and the approximate ground plane is then based on a distance from a location where the machine contacts the ground and the scanner. Identifying the obstacles can include identifying cells having a height above a threshold where the height value is the height of a point of a cell above the approximate ground plane. In one embodiment, the identifying the obstacles in the area further includes forming segments by combining cells having a height value above a threshold and can also include determining that the segment contains a number of cells above a threshold and identifying a segment as an obstacle in response to the determining that the segment contains the number of cells above the threshold. The obstacles can be classified based on the point cloud. The method can include generating a series of point clouds by the scanner over time and tracking the obstacles based on the series of point clouds. In one embodiment, the obstacles are classified based on output of a convolutional neural network and the output is generated based on identified segments of one of the obstacles.

An apparatus for obstacle detection, classification, and tracking including a scanner and a processor and a computer readable medium storing computer program instructions for obstacle detection, classification, and tracking are also described.

### BRIEF DESCRIPTION OF THE DRAWINGS

FIG. 1A shows a stereo camera for scanning an area according to one embodiment;

FIG. 1B shows a lawn mower on which the stereo camera of FIG. 1A is mounted;

FIG. 2A shows an image captured using an image sensor of the stereo camera of FIG. 1;

FIG. 2B shows a 3D point cloud of the area shown in the image of FIG. 2A;

FIG. 3 shows a cell map constructed using a cell height algorithm according to one embodiment;

FIG. 4 shows a map of the area shown in the image of FIG. 2A produced using morphological filtering of the cell map of FIG. 3 according to one embodiment;

FIG. 5 shows a map of the area shown in the image of FIG. 2A having a single connectivity component according to an embodiment;

FIG. 6 shows a map of the Earth's surface that is in view of the stereo camera of FIG. 1 according to one embodiment;

FIG. 7A shows a map of the area shown in the image of FIG. 2A having obstacle points identified according to one embodiment;

FIG. 7B shows a map of the result of segmentation of the map of FIG. 7A according to one embodiment;

FIG. 8 shows obstacles identified in view of the stereo camera of FIG. 1 according to one embodiment;

FIG. 9A shows the result of an identification convolutional neural network (“CNN”) used to identify obstacles according to one embodiment;

FIG. 9B shows the result of a classification CNN used to classify obstacles according to one embodiment;

FIG. 10 shows the result of object classifier in which obstacles are shaded according to one embodiment;

FIG. 11A shows obstacles in an area at a first time epoch;

FIG. 11B shows obstacles in an area at a second time epoch;

FIG. 11C shows obstacles in an area at a third time epoch;

FIG. 12 shows a flowchart of a method for identifying, classifying, and tracking obstacles according to one embodiment; and

FIG. 13 shows a high-level block diagram of a computer according to one embodiment.

### DETAILED DESCRIPTION

A method for obstacle detection, classification, and tracking comprises scanning an area surrounding a machine using a sensor (e.g., a 3D sensor) to generate a point cloud. The point cloud is then analyzed using various techniques to detect objects in the area surrounding the machine (e.g., obstacles can be identified based on points in the point cloud). The detected objects are then classified and tracked. The result of the detection, classification, and tracking can be used to facilitate autonomous operation of the machine on which the sensor is mounted or provide obstacle information to an operator of the machine. The method is described below in connection with an autonomous lawn mower (“machine”) but the method can be used with other types of machines.

In one embodiment, the method begins with scanning an area around the machine using a scanner that is mounted on a known location on the machine. The scanner, in one embodiment, is a sensor (i.e., a 3D sensor) such as, for example, a stereo camera, LiDAR, or Time of Flight (“ToF”) camera. The sensor can be oriented in various positions so that its faces forward, backward, or sideways relative to the front of the machine and/or the direction of travel during operation of the machine. In one embodiment, the sensor is titled downward so that the surface on which the machine travels is in the field of view of the sensor. The sensor generates information based on the scanning of the area surrounding the machine. In one embodiment, the sensor generates a point cloud and the color (i.e., the RGB values), black and white (“B&W”), and/or brightness information for each point of the cloud can also be determined.

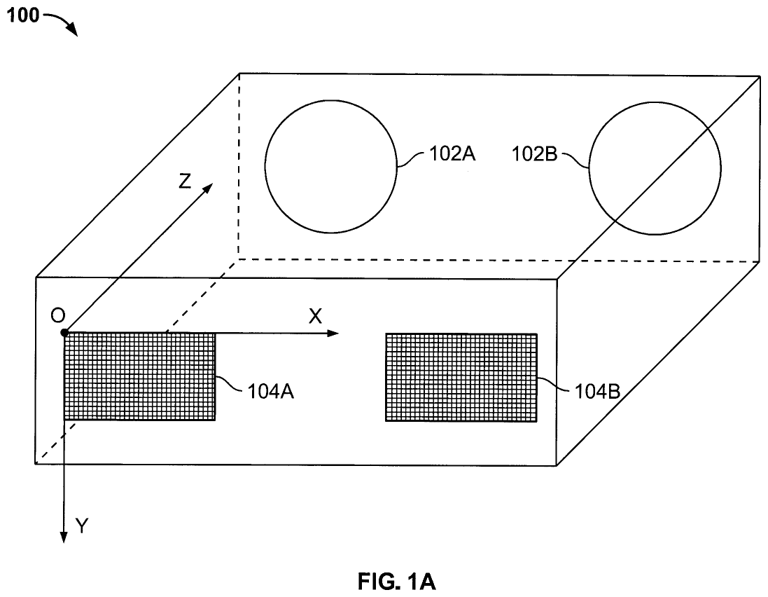

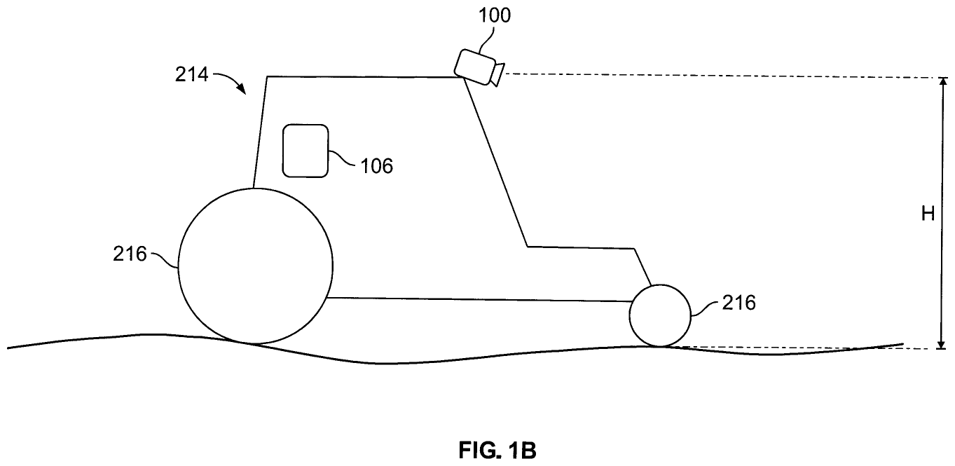

FIG. 1A shows stereo camera 100 having lenses 102A, 102B each of which focus an image on one of image sensors 104A, 104B respectively. In one embodiment, a 2D B&W image is obtained using one of the image sensors (e.g., image sensor 104A) and a 3D point cloud is generated using information from both image sensors 104A, 104B. The pixels of the 2D B&W image and the 3D point cloud are associated with a common local coordinate system of camera 100. In one embodiment, a Cartesian coordinate system is used as a local coordinate system that is common to both image sensors 104A, 104B. The common local coordinate system has an origin O located in an upper left corner of image sensor 104A. The common local coordinate system has three axes with the X-axis being horizontal, the Y-axis being vertical, and the Z-axis being perpendicular to both the X-axis and Y-axis. FIG. 1B shows stereo camera 100 located on the roof of lawn mower 214. Stereo camera 100 is in communication with processing unit 106 shown located inside the cab of lawn mower 214. In one embodiment, processing unit 106 performs methods, steps, and/or operations described herein based on data received from stereo camera 100. In one embodiment, stereo camera 100 is mounted to the roof of lawn mower 214 titled downward so that stereo camera 100 captures images of the area in front of lawn mower 214. It should be noted that the vertical distance H from the bottom of wheels 216 of lawn mower 214 to image sensors 104A, 104B of stereo camera 100 is known.

Sensor 100 is used to obtain images of an area in which obstacles may be located. In one embodiment an identification convolutional neural network (“CNN”) is used to find obstacles in an image and a segmentation or detection CNN is used to classify obstacles. The identification CNN uses a 2D frame (i.e., image) from image sensor 104A of stereo camera 100 to obtain initial information.

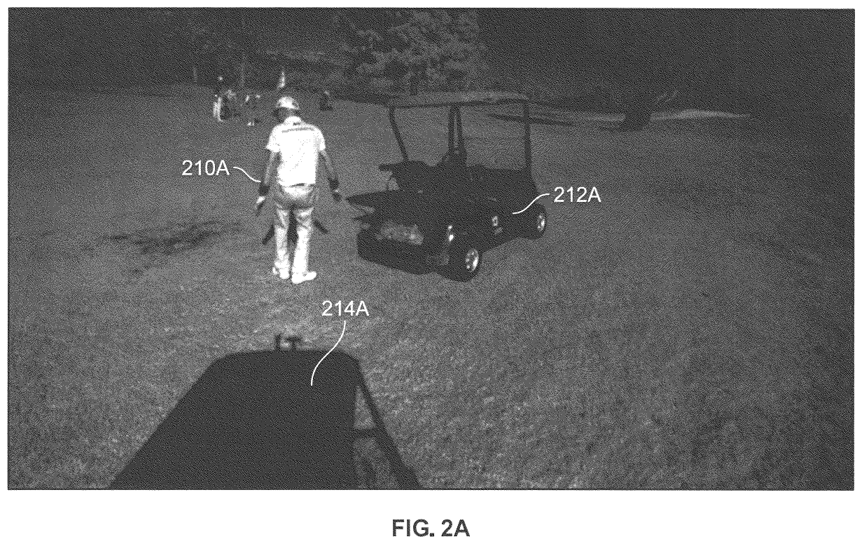

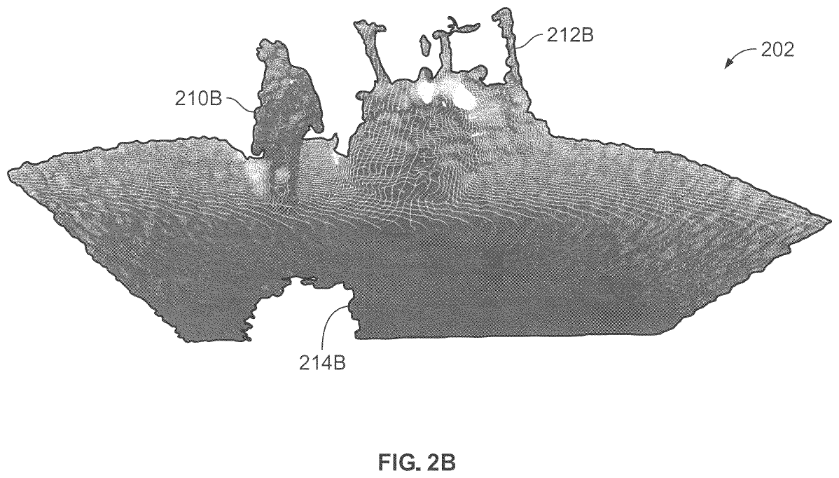

FIG. 2A shows a B&W image 200 captured using image sensor 104A. Image 200 shows human 210A near golf cart 212A and shadow 214A of lawn mower 214 on which stereo camera 100 is located. FIG. 2B shows 3D point cloud 202, captured using image sensors 104A and 104B, which shows pixelated versions of the objects shown in image 200. Specifically, pixelated human 210B is shown near pixelated golf cart 212B and pixelated shadow of lawn mower 214B.

After a 3D point cloud is acquired, an approximate ground plane is determined based on the 3D point cloud and information about the position and orientation of stereo camera 100 on the lawn mower. In one embodiment, the ground plane is the ground on which the lawn mower can travel. The ground plane does not include flora or growth such as tall grass or bushes that may obscure a view of the ground plane.

In one embodiment, the ground plane is determined using the 3D point cloud data and a random sample consensus (RANSAC) algorithm. Since the location of stereo camera 100 mounted on the lawn mower is known, the approximate location of the ground plane is known as well. This is because the vertical distance H from the bottom of the wheels of the lawn mower to the image sensing component of stereo camera 100 is known. As such, the location of the ground plane in any particular area of the 3D point cloud can be assumed to be within a specific distance above or below the height of a ground plane estimated using the known vertical distance H from the bottom of the wheels of lawn mower 214 (as shown in FIG. 1B) to image sensors 104A, 104B of stereo camera 100.

In one embodiment, the 3D point cloud is transformed by translation and rotation based on the height, roll, and pitch angles of stereo camera 100 so that the determined ground plane lies in the xOz plane of the local coordinate system of stereo camera 100.

In one embodiment, the Cartesian coordinate system (x,y,z) used for the coordinate system of stereo camera 100 is converted to a cylindrical coordinate system (r,a,h):

r=sqrt(x*x+z*z)

a=a tan(z/x)

h=−y

The h coordinate represents the vertical distance from a point of the 3D point cloud to the determined ground plane. As described herein, obstacles can be identified based on points in a point cloud in relation to the ground plane. In one embodiment, the determined ground plane is split into cells in the cylindrical coordinate system and the height of each cell is determined based on the information from the 3D point cloud. The height of each cell can be calculated using all points of the cloud that are located in the cell. A point is located in a cell if a projection of the point onto the rOa plane is located within a boundary of the cell. In one embodiment, the following cell height algorithm is used to calculate the height of a cell. First, all points located in a cell are sorted by their height. Next, a sliding window is used to vertically group points in a cell. In one embodiment, the points of the cell are grouped vertically from one point to a higher point. A window value is calculated by subtracting the number of points below the window from the number of points within the window. A position of the window having the maximum window value is used as an estimate of the height of the cell.

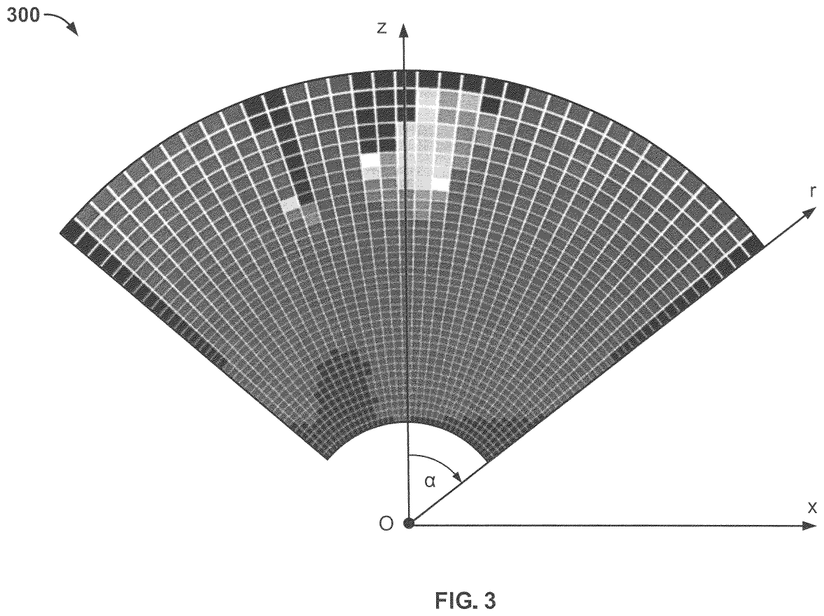

FIG. 3 shows cell map 300 constructed using the cell height algorithm. Plane rOa in the cylindrical coordinate system is shown coincident with the xOz plane in the Cartesian coordinate system. The shading of a cell identifies the height of the cell. The higher the height of the cell, the less shading in shown in the cell. A black shaded cell indicates that not a single point of the point cloud is included in that cell.

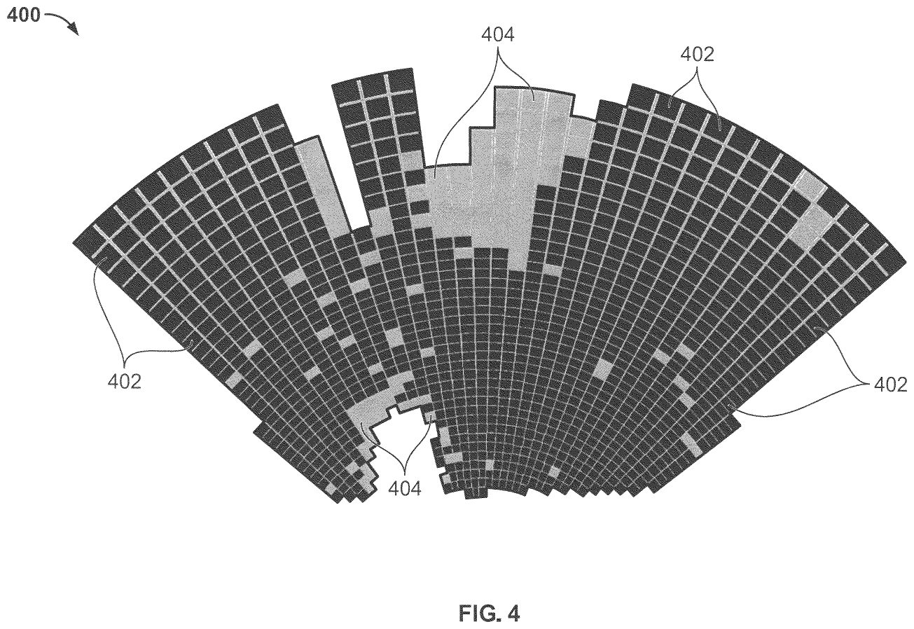

Cell map 300 shown in FIG. 3 is converted to map 400 of FIG. 4 using filters. In one embodiment, morphological filtering operators are used to identify cells of a map that have a height higher than a threshold. The cells that have a height higher than the threshold are excluded from a ground plane and the remaining cells are considered to be cells of the ground plane (i.e., the Earth's surface). In one embodiment, a sequence of erosion and dilation (i.e., an opening operation) are used as a filtration operator.

In one embodiment, each cell is indexed using the r and a values and each cell uniquely corresponds to a pair of indexes in r and a. In one embodiment, the erosion operation is defined using a radius w and for each cell: 1) considering all cells, both indexes which differ from the corresponding indexes of the original cell by no more than w; 2) identifying the minimum height among the considered cells; and 3) setting a new height of the source cell equal to this minimum height.

In one embodiment, the dilation operation is defined using a radius w and is similar to the erosion operation except that the dilation operation identifies a maximum height instead of a minimum height. In one embodiment, the opening operation is defined using a radius w as a sequential execution of the erosion and dilation operations both using a radius w.

In one embodiment, the minimum and maximum values of w are set. For each value of w, the height threshold dH(w)=w*dh1+dh0 is calculated where dh0 and dh1 are user defined parameters. In one embodiment, the opening operation is performed while gradually increasing w from the minimum value to the maximum value. After each opening operation, cells having heights that have decreased by more than dH(w) are identified for subsequent filtering.

In one embodiment, the height of all cells are returned to their original values before applying the opening operations. The cells stored during the application of the opening operations are identified as “not Earth” and the remaining cells are identified as “Earth”.

FIG. 4 shows map 400 of the area shown in the image of FIG. 2A that is produced using the morphological filtering on cell map 300 of FIG. 3 as described above. Black cells 402 are cells classified as “Earth” and shaded cells 404 are classified as “not Earth”. In one embodiment, cells classified as “Earth” can be represented as a graph, where the vertices of the graph are the cells of the Earth and the cells are connected (i.e., have a common node) if the height difference between the cells is small and the cells are neighboring cells. In one embodiment, the “Earth” cells are combined into connectivity components (i.e., contiguous areas).

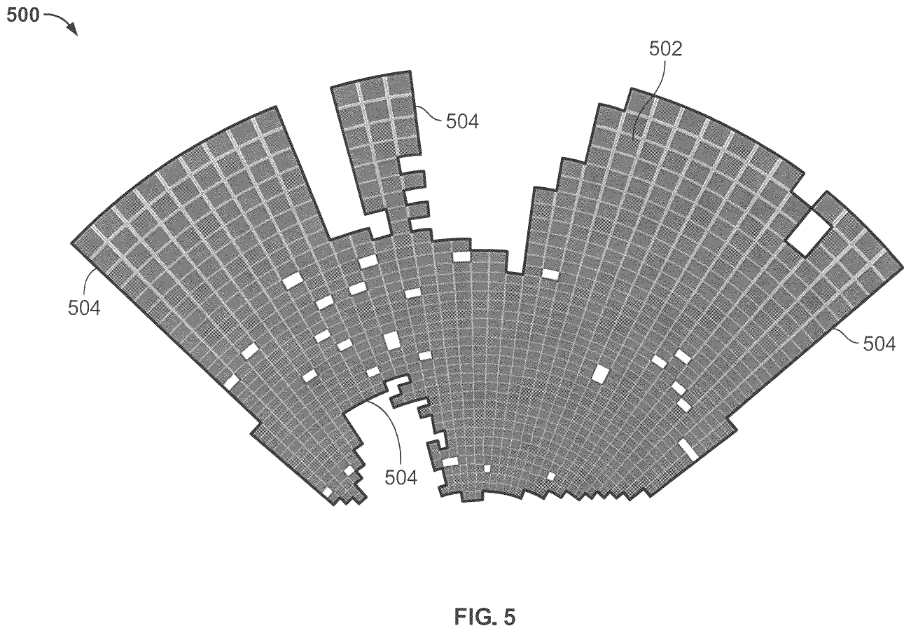

FIG. 5 shows map 500 of the area shown in the image of FIG. 2A having a single connectivity component 502. The single connectivity component 502 is a single contiguous area of cells which is formed from all “Earth” cells using the morphological filtering. As shown in FIG. 5, the border of connectivity component 502 is shown as bold line 504. Also as shown in FIG. 5, bold line 504 contrasts with the shading of cells included in connectivity component 502.

In one embodiment, the height of the Earth's surface in the cells not included in connectivity component 502 (i.e., the cells marked as “not Earth”) is determined by interpolation or extrapolation based on information from cells located in connectivity component 502.

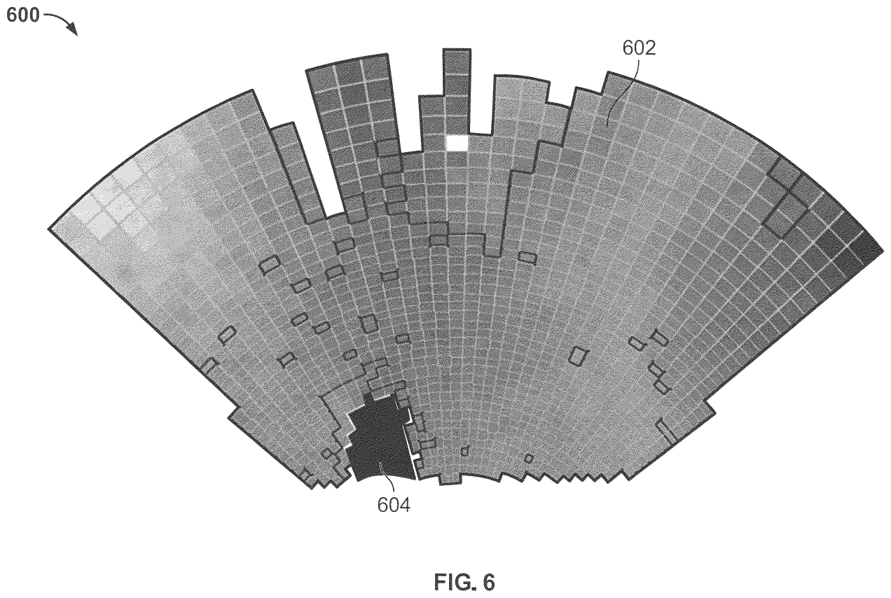

FIG. 6 shows map 600 which is a complete map of the Earth's surface that is in view of stereo camera 100. Map 600 includes all cells that have been identified as Earth's surface and has bold lines that border connectivity component 602 and other cells that have an interpolated/extrapolated height. The height of the cells on map 600 are different with cells having a higher height being shown having lighter shading than cells having a lower height. In this embodiment, a flat plane is not used as a surface underlying the cells. The actual variable height of the area within the view of stereo camera 100 is used which is important in applications in which stereo camera 100 is viewing off-road conditions. Not all cells shown in FIG. 6 have height information. In one situation, a cell has no height information because no points from the 3D point cloud were associated with those cells. Black hole 604 is formed of a collection of neighboring cells for which no height information is available. Such areas do not contain information that can be analyzed to find obstacles. Those areas are not observable based on data from stereo camera 100 and pose the same danger as obstacles.

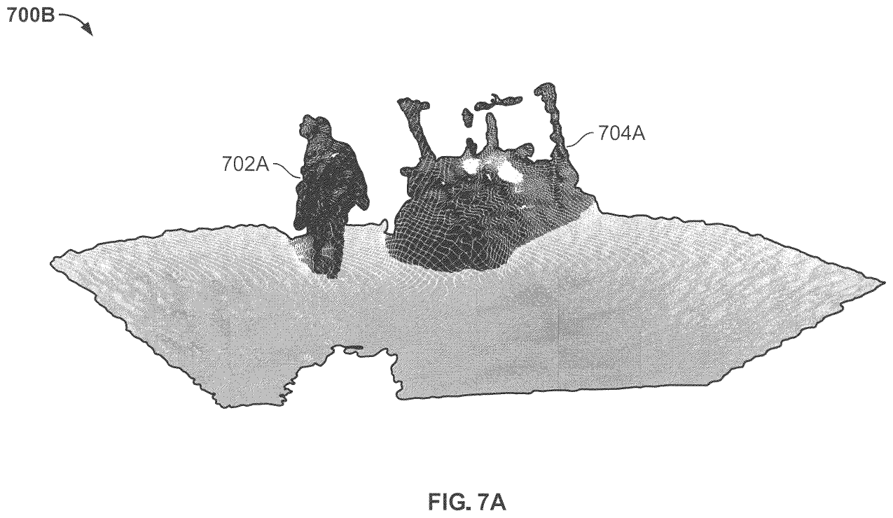

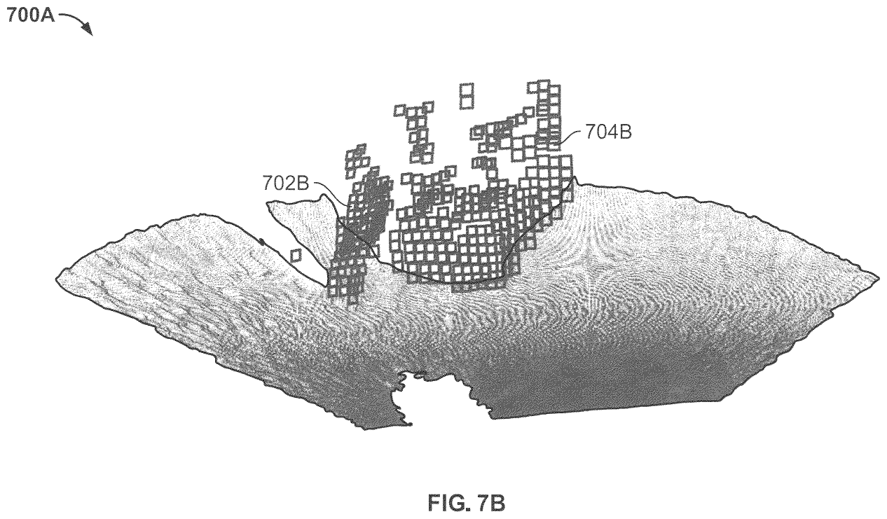

Next, all points in the 3D point cloud that are above the map of the Earth's surface by a given threshold are identified and marked as obstacle points. FIG. 7A shows map 700A of the area shown in the image of FIG. 2A having obstacle points marked in black and forming obstacles 702A, 704A.

In one embodiment, the points marked as obstacle points are combined into segments in a spherical camera coordinate system where φ is longitude, θ is latitude, and p is radius which are determined using the equations:

$$\{ \begin{matrix}ρ = \sqrt{{x}^{2} + {y}^{2} + {z}^{2}} , \\ cos φ = \frac{x}{\sqrt{{x}^{2} + {y}^{2}}} , \\ sin φ = \frac{y}{\sqrt{{x}^{2} + {y}^{2}}} , \\ θ = arccos \frac{z}{ρ} = arccos \frac{z}{\sqrt{{x}^{2} + {y}^{2} + {z}^{2}}} .\end{matrix}$$

In one embodiment, the spherical coordinate system is divided into segments based on the angular coordinates φ and θ in constant increments do and de. In this embodiment, each segment contains all marked points that are associated with the segment (i.e., the angular coordinates of each marked point are located inside the segment). If there are fewer points in the segment than a specified number, the segment is excluded from the analysis for being insufficiently representative. Next, the third ρ coordinate is determined for each segment. In one embodiment, this is performed by ranking all points belonging to the segment by ρ. After ranking, 10% of points with minimum and maximum ρ are excluded. This allows for exclusion of abnormal points. In one embodiment, the ρ-coordinate for the segment is the ρ of closest (with minimal ρ) point (from the remaining set) to the camera. As a result, we have segments, each of which has its own coordinates φ, θ and ρ. FIG. 7B shows map 700B of the result of the segmentation of the map of FIG. 7A. Squares show segments of obstacles 702B, 704B in the spherical coordinate system.

In one embodiment, obstacles are formed based on vertices of a graph which are considered segments of obstacles. In one embodiment, vertices are the remaining segments, after excluding segments with a small number of points. Two graph vertices are connected by a node if the segments are adjacent based on coordinates φ and θ and are located close to each other with respect to ρ. As a result, an undirected unweighted graph without loops and multiple edges is produced.

In one embodiment, the connectivity components in the graph are isolated by traversing the graph in depth. In one embodiment, the connectivity components are isolated using a standard component algorithm. All connectivity components are identified where a connectivity component is a set of connected vertices of a graph (each vertex uniquely corresponds to some segment). In one embodiment, the set of segments (connectivity components) are identified as potential obstacles.

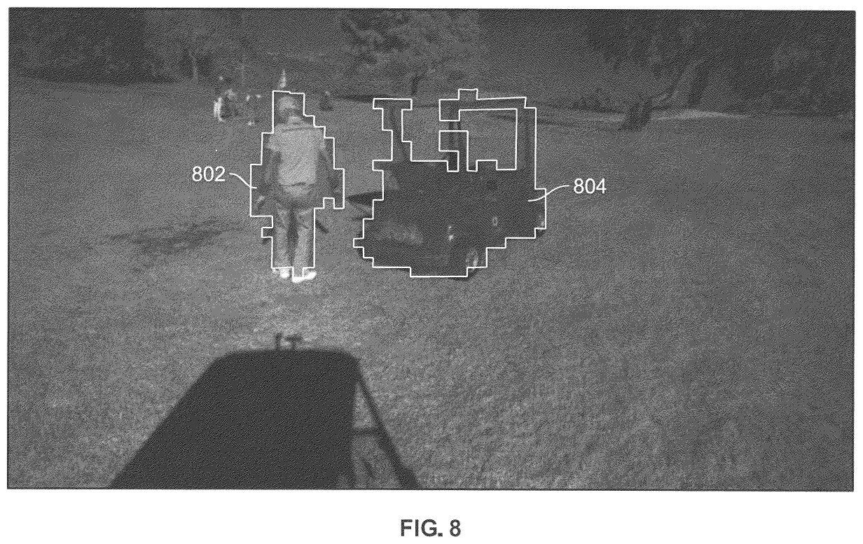

FIG. 8 shows obstacles 802, 804 (i.e., segment connectivity components) based on the view of stereo camera 100 that have been identified using the method described above.

After obstacle search and identification described above is complete, obstacle classification begins. In one embodiment a segmentation or detection CNN is used to classify obstacles. In a first embodiment, a segmentation neural network assigns each pixel of the camera image a class from a predefined set (for example, a “person”, “vehicle”, “golf equipment”) or background in case when a pixel has no classification from the neural network. In a section embodiment, the detection neural network produces a set of circumscribed rectangles (bounding boxes) corresponding to objects, each rectangle is assigned a class from a predefined set. The classes are indexed according to priority. For example: people=1, vehicle=2, golf staff=3. A smaller index is higher priority. In one embodiment, people are more important than vehicles, vehicles are more important than golf equipment.

In one embodiment, the class of each pixel is defined by: 1) if the pixel is not within any of the bounding boxes, it is identified as background; 2) if a pixel falls into one or more bounding boxes of the same class, the pixel is considered to be that same class; 3) if a pixel falls into several different bounding boxes, this is the class of pixel with the minimum index (i.e., the most important). In one embodiment, for both options (i.e., segmentation or detection CNN) a class from a predefined set or background for each pixel in the image is identified.

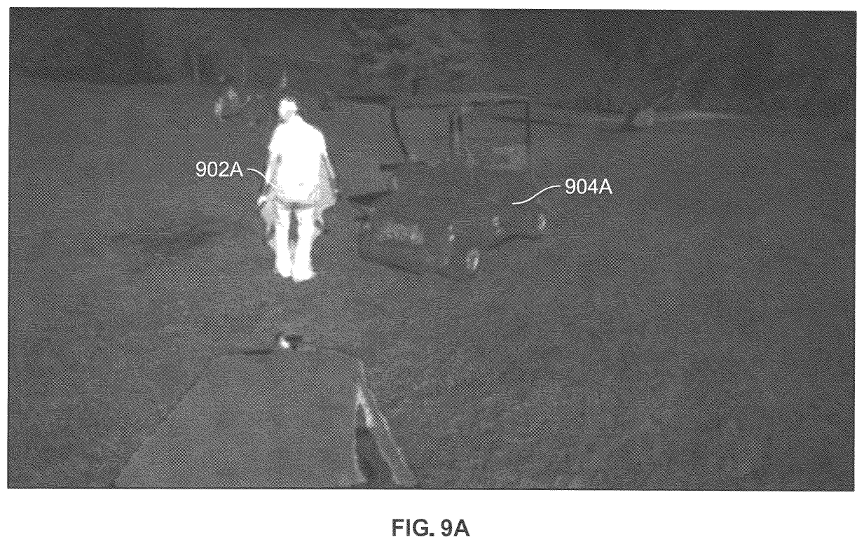

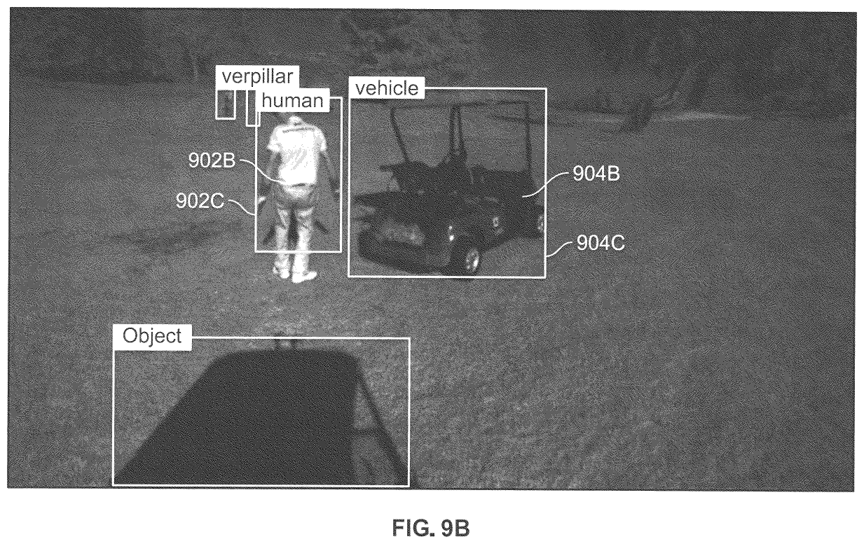

FIG. 9A shows the result of CNN segmentation of images from stereo camera 10θ in which obstacles 902A, 904A have been identified. FIG. 9B shows the result of CNN classification in which obstacles 902B, 904B are shown surrounded by bounding boxes 902C, 904C. Although not shown in the FIGS., in one embodiment, objects can be colored based on their classification. For example, vehicles can be shown in red and humans shown in yellow. In one embodiment, the bounding box surrounding a classified obstacle includes a text identification of the class of obstacle.

In one embodiment, each segment is defined by the range of φ and θ and each pixel of the image corresponds to some values of φ and θ. These values depend only on the pixel position in the image and the camera parameters. Thus, each segment corresponds to some set of pixels of the image.

Previously, an obstacle was defined as a set of connected segments. In one embodiment, is assumed that all pixels corresponding to its segments correspond to the obstacle. To determine the obstacle class, the number of pixels of all classes and background among the pixels corresponding to this obstacle are counted. The resulting values are multiplied by the class weights specified by user. The weight value reflects the significance of the class. The class with the maximum value is selected. If it is background, then the class is not assigned to the obstacle (the obstacle remains not classified).

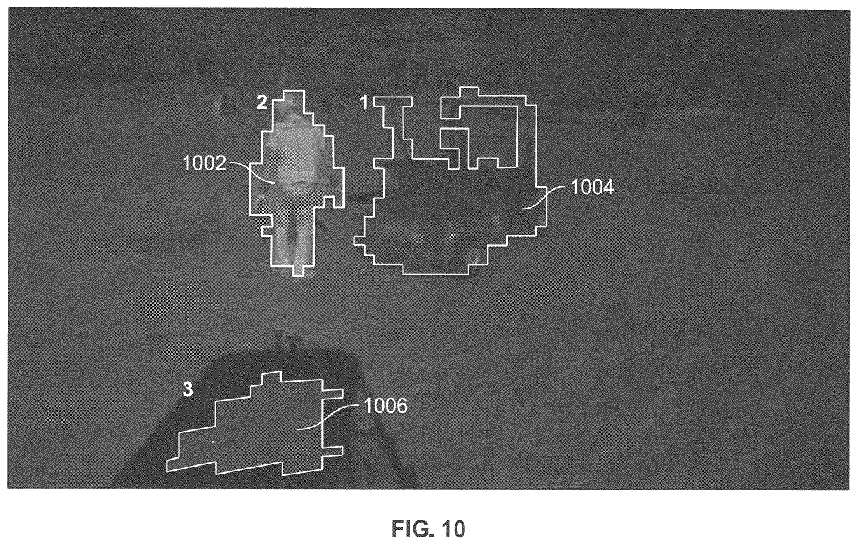

FIG. 10 shows the result of the obstacle classifier in which vehicle 1004 is shaded a particular color (e.g., red), human 1002 is shaded a different color (e.g., yellow) and black hole 1006 (i.e., an area that cannot be identified) is shaded yet another color (e.g., green). It should be noted that although obstacles are not shaded using colors in the FIGS., obstacles can be shaded in various implementations as described herein.

In one embodiment, the above identification and classification of obstacles is performed for each time epoch. A sequence of time epochs can be used to track obstacles over time. Each frame captured by stereo camera 10θ is associated with a time epoch. Obstacles in a current frame are matched with obstacles found in prior frames to track the obstacle over time.

In one embodiment, a Kalman filter is used to track obstacles. The Kalman filter, in one embodiment, has seven steps starting with a prediction by the Kalman filter one frame ahead of all past obstacles. Next, for all possible pairs of current obstacle/past obstacle, a matching price is calculated using the distance between the centers of mass of the of the obstacles and an IOU metric. The IOU metric, in one embodiment, is the division of the area of intersection of two obstacles by sectors by the total area of these obstacles by sectors. A matrix is then compiled based on prices of matching obstacles to one another. Then, using the Hungarian algorithm, optimal ones are selected in a manner that minimizes the total cost of matching obstacles. The Kalman filters are then updated based on past obstacles that have been matched to current obstacles. Kalman filters for past obstacles that did not have a sufficient number of frames to match with current obstacles are removed. Kalman filters for current obstacles that have not been matched among past obstacles are created and the process repeats.

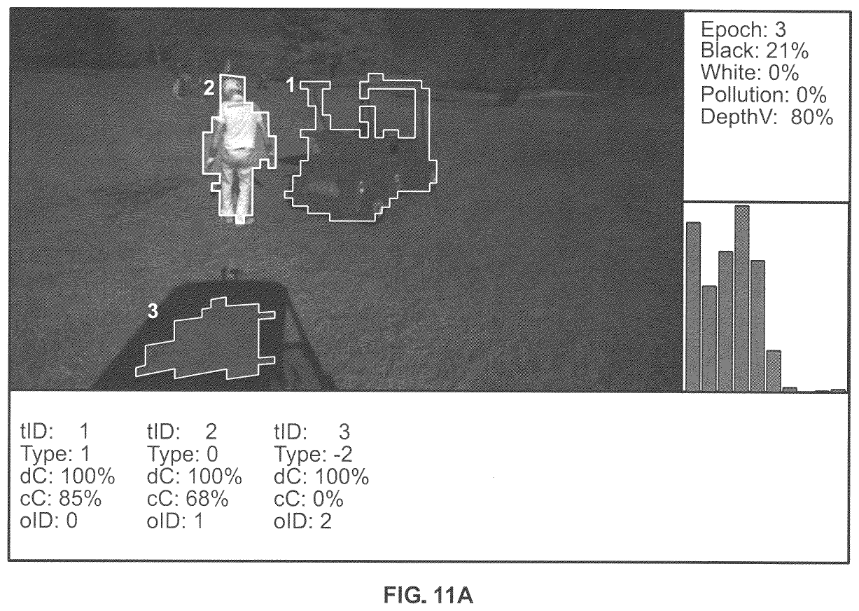

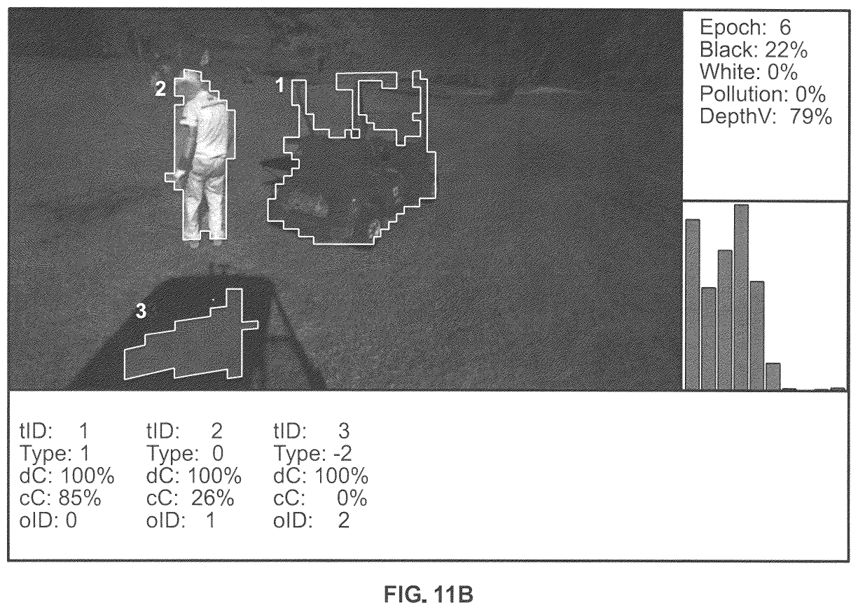

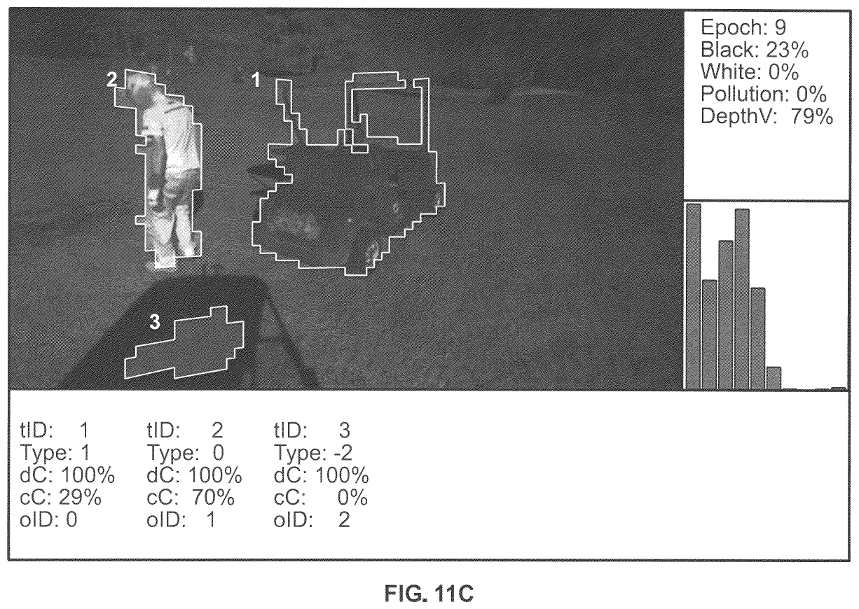

FIGS. 11A, 11B, and 11C show three frames captured by stereo camera 100 during movement of the lawn mower on a golf course. As can be seen in FIGS. 11B and 11C, the human shown in FIG. 11A has moved over the time that the frames were captured. In one embodiment, the frames shown in FIGS. 11A, 11B, and 11C can include information regarding the obstacles located in the frames. In one embodiment, the frames of each of FIGS. 11A, 11B, and 11C includes a legend. In one embodiment, the legend includes the following information. Epoch identifies the frame number. Black identifies the percentage of pixels in the 2D frame having a brightness of 0-25. White identifies the percentage of pixels in the 2D frame having a brightness of 230-255. Pollution identifies the degree of contamination of the camera lenses as a percentage. DepthV is the percentage of points in the 3D cloud obtained from the camera from the maximum possible. In one embodiment, frames can include a legend for one or more obstacles and contain the following information. tID is a unique number associated with the obstacle. Type identifies the class of the obstacle (e.g., −2/−1/0/1/2/3/4 represent black hole/not classified/person/vehicle/animal/poles/golf equipment). dC is the confidence of obstacle detection as a percentage. cC is the confidence of obstacle classification as a percentage. oID is the obstacle sequence number for the current epoch (frame).

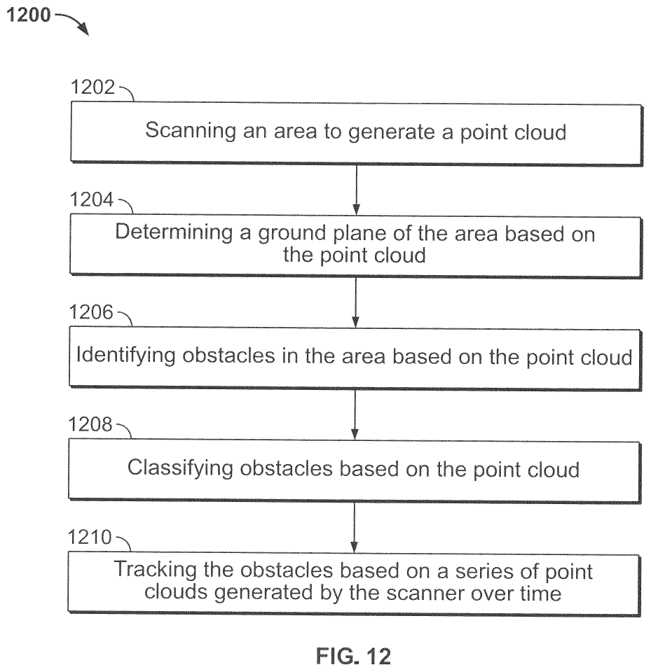

FIG. 12 shows a flowchart 1200 of a method for identifying, classifying, and tracking obstacles according to one embodiment. In one embodiment, at step 1202 an area is scanned using a scanner, such as stereo camera 100 of FIG. 1, to generate a point cloud of the area as described above in connection with FIG. 2B. In one embodiment, the point cloud is transmitted to processing unit 106 shown in FIG. 2B where steps 1204 to 1210 are performed. At step 1204 a ground plane of the area is determined based on the point cloud as described above in connection with FIGS. 2B and 3. At step 1206, obstacles in the area are identified based on the point cloud as described above in connection with FIGS. 4-8. At step 1208, obstacles are classified based on the point cloud as described above in connection with FIGS. 9A-10. At step 1210, obstacles are tracked based on a series of point clouds generated by the scanner over time as described above in connection with FIGS. 11A-11C.

In one embodiment, the determining the ground of the area comprises dividing an approximate ground plane into a plurality of cells. A maximum height of points in each of the plurality of cells above the approximate ground plane are then determined and each of the plurality of cells is categorized into one of a ground plane or not a ground plane based on the maximum height of points in a respective one of the plurality of cells. The approximate ground plane, in one embodiment, is based on the distance from a location where a machine to which the scanner is mounted contacts the ground to the scanner. In one embodiment, the identifying obstacles in the area comprises identifying cells having a height value above a threshold where the height value is the height of a cell above the approximate ground plane. In one embodiment, the identifying obstacles in the area further comprises forming segments by combining the cells having a height value above the threshold. The identifying obstacles in the area, in one embodiment, further comprises identifying a segment of an obstacle in response to determining that the segment contains a number of cells above a threshold. In one embodiment, the classifying the obstacles uses a convolutional neural network to classify obstacles based on the identified segments of one of the obstacles.

It should be noted that a “ground plane” does not need to be flat. A ground plane can be any arbitrary surface. For example, a field for playing golf can have a hummocky surface (i.e., a surface including one or more low mounds, ridges, or knolls). The methods and algorithms described herein can be used to find obstacles on a surface having an unsteady/uneven height. In one embodiment, first obstacles over the surface are identified in a 3D point cloud to isolate those obstacles. Then the obstacles are classified using a neural network based on the camera's frame. Following this sequence avoids false detection of obstacles by a neural network. For example, a neural network may process the shadow of an object in an image despite the object causing the shadow not being in the image. For example, a person can cast a shadow on a surface and a neural network could classify the shadow as a person. By following the sequence above, the shadow of the person would not be identified as an obstacle because the shadow would not be identified as being located above the surface and would, therefore, be considered part of the ground plane.

Where the system and methods described herein are used can affect how obstacle information is used. In one embodiment, the systems and methods described herein are used in connection with an autonomous mowers used at golf courses. In one embodiment, the type of obstacle determines how a vehicle, such as an autonomous mower will respond. If the obstacle is a person, the autonomous mower will not move until the person moves out of the area. If the obstacle is determined to be a vehicle, the autonomous mower will reduce its speed and try to go around the vehicle. If the obstacle is determined to be golf equipment, the autonomous mower will go around the golf equipment, assuming that the golf equipment is stationary.

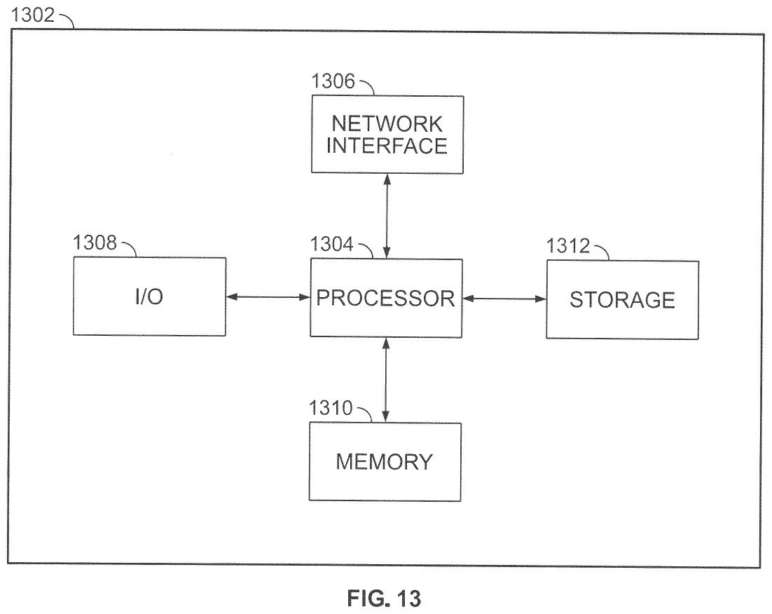

Scanner 100 and processing unit 106, as well as the methods and techniques described herein can be implemented using one or more computers. For example, the method shown in FIG. 12 can be implemented using a computer. A high-level block diagram of such a computer is illustrated in FIG. 13. Computer 1302 contains a processor 1304 which controls the overall operation of the computer 1302 by executing computer program instructions which define such operation. The computer program instructions may be stored in a storage device 1312, or other computer readable medium (e.g., magnetic disk, CD ROM, etc.), and loaded into memory 1310 when execution of the computer program instructions is desired. Thus, the method steps of FIG. 12 can be defined by the computer program instructions stored in the memory 1310 and/or storage 1312 and controlled by the processor 1304 executing the computer program instructions. For example, the computer program instructions can be implemented as computer executable code programmed by one skilled in the art to perform an algorithm defined by the method steps of FIG. 12. Accordingly, by executing the computer program instructions, the processor 1304 executes an algorithm defined by the method steps of FIG. 12. The computer 1302 also includes one or more network interfaces 1306 for communicating with other devices via a network. The computer 1302 also includes input/output devices 1308 that enable user interaction with the computer 1302 (e.g., display, keyboard, mouse, speakers, buttons, etc.) One skilled in the art will recognize that an implementation of an actual computer could contain other components as well, and that FIG. 13 is a high-level representation of some of the components of such a computer for illustrative purposes.

The foregoing Detailed Description is to be understood as being in every respect illustrative and exemplary, but not restrictive, and the scope of the inventive concept disclosed herein should be interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method comprising:
scanning an area using a scanner to generate a point cloud; determining a ground plane of the area based on the point cloud; and
identifying obstacles in the area based on points in the point cloud in relation to the ground plane.

2. The method of claim 1, wherein determining the ground plane of an area comprises:
dividing an approximate ground plane into a plurality of cells;
determining a maximum height of points in each of the plurality of cells above the approximate ground plane; and
categorizing each of the plurality of cells into one of a ground plane or not a ground plane based on the maximum height of points in the cell.

3. The method of claim 2, wherein the scanner is mounted on a machine, and the approximate ground plane is based on a distance from a location where the machine contacts the ground and the scanner.

4. The method of claim 2, wherein identifying obstacles comprises:
identifying cells having a height value above a threshold, wherein the height value is the height of a point of a cell above the approximate ground plane.

5. The method of claim 4, wherein identifying obstacles in the area further comprises:
forming segments by combining cells having a height value above the threshold.

6. The method of claim 5, wherein identifying obstacles in the area further comprises:
determining that the segment contains a number of cells above a threshold; and
identifying a segment as an obstacle in response to the determining that the segment contains the number of cells above the threshold.

7. The method of claim 1, further comprising:
classifying the obstacles based on the point cloud.

8. The method of claim 1, further comprising:
generating a series of point clouds by the scanner over time; and
tracking the obstacles based on the series of point clouds.

9. The method of claim 1, further comprising:
classifying the obstacles based on output of a convolutional neural network, the output generated based on identified segments of one of the obstacles.

10. An apparatus comprising:
a scanner configured to scan an area and generate a point cloud; and
a processor in communication with the scanner, the processor configured to perform operations comprising:
determining a ground plane of the area based on the point cloud; and
identifying obstacles in the area based on points in the point cloud in relation to the ground plane.

11. The apparatus of claim 10, wherein determining the ground plane of the area comprises:
dividing an approximate ground plane into a plurality of cells;
determining a maximum height of points in each of the plurality of cells above the approximate ground plane; and
categorizing each of the plurality of cells into one of a ground plane or not a ground plane based on the maximum height of points in the cell.

12. The apparatus of claim 11, wherein the scanner is mounted on a machine, and the approximate ground plane is based on a distance from a location where the machine contacts the ground and the scanner.

13. The apparatus of claim 11, wherein identifying obstacles comprises:
identifying cells having a height value above a threshold, wherein the height value is the height of a point of a cell above the approximate ground plane.

14. The apparatus of claim 13, wherein identifying obstacles in the area further comprises:
forming segments by combining cells having a height value above the threshold.

15. The apparatus of claim 14, wherein identifying obstacles in the area further comprises:
determining that the segment contains a number of cells above a threshold; and
identifying a segment as an obstacle in response to the determining that the segment contains the number of cells above the threshold.

16. The apparatus of claim 10, the operations further comprising:
classifying the obstacles based on the point cloud.

17. The apparatus of claim 10, the operations further comprising:
generating a series of point clouds by the scanner over time; and
tracking the obstacles based on the series of point clouds.

18. The apparatus of claim 10, the operations further comprising:
classifying the obstacles based on output of a convolutional neural network, the output generated based on identified segments of one of the obstacles.

19. A computer readable medium storing computer program instructions, which, when executed on a processor, cause the processor to perform operations comprising: receiving a point cloud from a scanner based on a scan of an area; determining a ground plane of the area based on the point cloud; and
identifying obstacles in the area based on points in the point cloud in relation to the ground plane.

20. The computer readable medium of claim 19, wherein determining the ground plane of the area comprises:
dividing an approximate ground plane into a plurality of cells;
determining a maximum height of points in each of the plurality of cells above the approximate ground plane; and
categorizing each of the plurality of cells into one of a ground plane or not a ground plane based on the maximum height of points in the cell.

21. The computer readable medium of claim 20, wherein the scanner is mounted on a machine, and the approximate ground plane is based on a distance from a location where the machine contacts the ground and the scanner.

22. The computer readable medium of claim 20, wherein identifying obstacles comprises:
identifying cells having a height value above a threshold, wherein the height value is the height of a point of a cell above the approximate ground plane.

23. The computer readable medium of claim 22, wherein identifying obstacles in the area further comprises:
forming segments by combining cells having a height value above the threshold.

24. The computer readable medium of claim 23, wherein identifying obstacles in the area further comprises:
determining that the segment contains a number of cells above a threshold; and
identifying a segment as an obstacle in response to the determining that the segment contains the number of cells above the threshold.

25. The computer readable medium of claim 19, the operations further comprising:
classifying the obstacles based on the point cloud.

26. The computer readable medium of claim 19, the operations further comprising:
generating a series of point clouds by the scanner over time; and
tracking the obstacles based on the series of point clouds.

27. The computer readable medium of claim 19, the operations further comprising:
classifying the obstacles based on output of a convolutional neural network, the output generated based on identified segments of one of the obstacles.
